(19) United States
(12) Patent Application Publication
(10) Pub. No.: US 2015/0326718 A1
(43) Pub. Date: Nov. 12, 2015

(54) Method and System to Unify the Authentication of Multiple Devices with Different Identifications

(71) Applicant: PingShow Inc., Cupertino, CA (US)

(72) Inventor: Shi-Chang Wang, San Jose, CA (US)

(21) Appl. No.: 14/656,713

(22) Filed: Mar. 13, 2015

Related U.S. Application Data
(60) Provisional application No. 61/992,209, filed on May 12, 2014.

(51) Int. Cl. H04M 3/42; H04M 3/56; H04M 7/00

(52) U.S. Cl. CPC H04M 3/42263; H04M 7/0075; H04M 3/56

(57) ABSTRACT

Techniques are provided for ubiquitous connection between various communication devices including PSTN phones and non-PSTN devices. A member based identification is used to link all different types of devices together and allows one phone connection request to reach all communication devices associated with the registered member. Furthermore, the communication covers not only phone devices but also different communication platforms and TVs.

### CROSS REFERENCE

This application claims the benefit of U.S. Provisional Application with Ser. No. 61/992,209, filed on May 12, 2014, the entire contents of both of which are hereby incorporated by reference as if fully set forth herein, under 35 U.S.C. §119(e).

### FIELD OF INVENTION

This disclosure generally relates to communication system. More specifically, it is related to a communication system that enables communication between PSTN phones and non-PSTN devices

### DESCRIPTION OF RELATED ART

In a modern and highly mobile world, people often travel or work in different geographical locations. How to stay connected while maintaining the desired mobility is a challenge. Currently, phone call is still the major way of voice communication although there are other devices (e.g. Personal Computer and Tablet) that can be used for data communication or text message. However, they are one-to-one connection. In other words, when a person (i.e. caller or a sender entity) places a phone call, the person can reach only one phone device. If the receiver (i.e. callee or a recipient entity) happens to be not available to receive the call, as an example, the receiver is away from the phone, or the phone is not within cellular range or runs out of battery, the receiver is very likely to miss the call. Therefore, methods and mechanisms to provide people freedom to communicate at anywhere and anytime is desired.

In addition, Television (TV) has been traditionally used for one-way communication to receive broadcast information. This role is being changed with the connection of the TV to the Internet. Furthermore, in a smart home, many sensors and surveillance devices are connected to TV. It is desirable for the caller to reach the TV (a non-PSTN device) and retrieve information from TV and all sensor information connected to TV. Vice versa, there is also a need to allow a TV to make phone calls, communicate with another TV or share information.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

Systems and methods for enabling ubiquitous connection and communication among various communication devices are contemplated. The communication devices can be either traditional Public Switch Telephone Network (PSTN) phone or non-PSTN devices (e.g. PC, tablet or TV).

In one embodiment, a communication system may receive a phone connection request with a target phone number from a source device. The communication system authenticates the phone connection request for access to a network by verifying identification of a recipient entity associated with the target phone number. The communication system further identifies a plurality of receiving devices associated with the recipient entity and connects and transmits signals from the source device to the plurality of receiving devices. The plurality of receiving devices may include at least one PSTN device and at least one non-PSTN device.

In another embodiment, a source network enabled TV may request a connection to at least one destination network enabled TV associated with a personal identification of a recipient entity. The communication system may look up a network identification of the at least one destination networked enabled TV and transmit signals from source networked enabled TV to the at least one destination networked enabled TV.

These and other embodiments will become apparent upon reference to the following description and accompanying drawings.

### BRIEF DESCRIPTION OF THE DRAWINGS

The present invention is illustrated by way of example, and not by way of limitation in the figures of the accompanying drawings and in which like reference numerals refer to similar elements and in which:

FIG. 1 is a generalized block diagram illustrating communications among users with different devices, according to an embodiment of the invention.

FIG. 2A is a generalize block diagram illustrating a lookup table, according to an embodiment of the invention.

FIG. 2B is a generalize block diagram illustrating another embodiment of lookup table, according to an embodiment of the invention.

FIG. 3 is a generalize block diagram illustrating a database, according to an embodiment of the invention.

FIG. 4 is a generalize block diagram illustrating a communication protocol between two communication platforms, according to an embodiment of the invention.

FIG. 5 is a generalize flow diagram illustrating a method for processing connection requests, according to an embodiment of the invention.

FIG. 6 is a generalize flow diagram illustrating another embodiment of a method for processing a connection request, according to an embodiment of the invention.

FIG. 7 is a generalized block diagram of a computer system upon which embodiments of the invention may be implemented.

### DETAILED DESCRIPTION

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

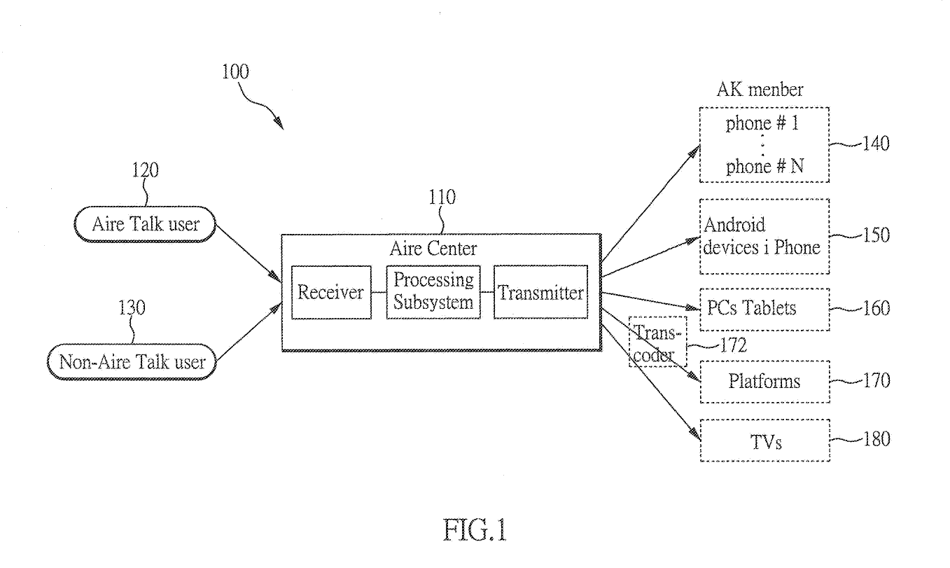

FIG. 1 is a generalized block diagram illustrating communications among users with different devices, according to an embodiment of the invention. The communication system 100 allows connection requests 120 and 130 to reach various kinds of devices 140-180 through a technology known as Universal Connectivity. The Universal Connectivity (UC) technology enables connection requests to reach and ring all devices including Public Switch Telephone Network (PSTN) phones 140-150 or non-PSTN devices, which do not utilize Public Switch Telephone Network for communication, such as PCs &Tablets 160, TVs 180 and other communication platforms 170 such as Skype™, Line, etc. The PSTN phone refers to a phone that is associated with a phone number assigned by a telephone company. The connection request may be initiated by a software application, a PSTN call or a TV.

In FIG. 1, AireCenter 110 is an infrastructure including both hardware and software enabling the Universal Connectivity technology. A term, AireTalk (refers to as AK hereafter), refers to a service provider of the Universal Connectivity technology and its registered member is referred to as an AireTalk member or AK member hereafter. When an AK member uses an application on AireTalk platform, it may be referred to as an AK user. Alternatively, when an AK member is using an application of a different platform, it may be referred to as a user of that particular platform, such as Skype user. A non-AK user may be referred to either a non-AK member or an AK member using a platform other than AireTalk.

In FIG. 1, AireTalk user 120 is a person who registers with AireTalk for all of the person's communication devices, including, but not limit to, the following types of devices, traditional phones, smart phones/devices, PCs & tablets, communication platform accounts (e.g. Skype or Line) and TV. A third party 130, who may not be an AK member, makes a connection request to reach an AK member who owns various kind of devices 140-180. Either one of the connection requests (120 and 130) goes through AireCenter 110 and eventually reaches all registered devices 140-180 of the receiving AK member about the same time. Since PSTN phone number of the connection request is ported to AireCenter 110, AireCenter 110 is able to process and route a traditional phone call (e.g. rotary phone or the like) to devices of an AK member. If the third party is an AK user, the user may use AireTalk application on a device to make the connect request. A conversion device or transcoder 172 may be needed between AireTalk platform and another platform 170, which will be described in more detail later.

AireCenter can be categorized into two parts. The first part is for phone connection called AireVoice with UC technology targeting communication among phones 140-150, smart devices 160 and platforms 170. The second part is for TV connection called AireTV with UC technology targeting communication between TVs 180. These technologies enable AK users to communicate with each other and share information at any time on various devices.

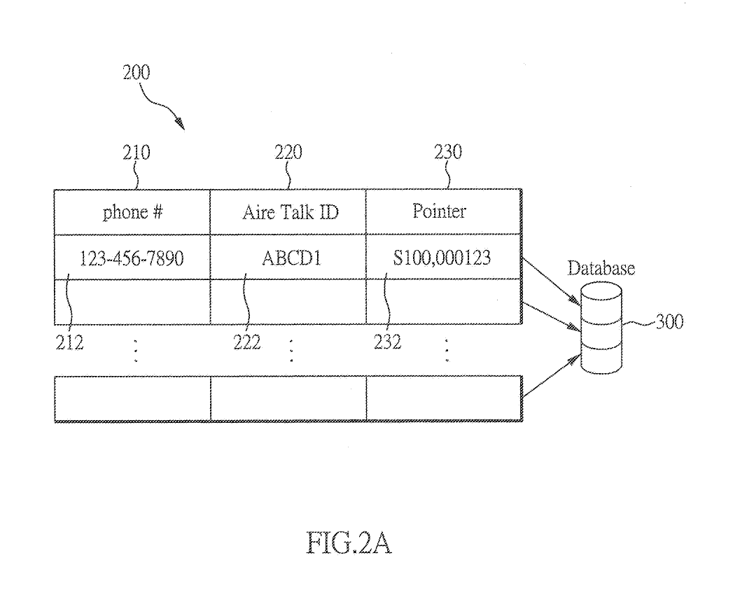

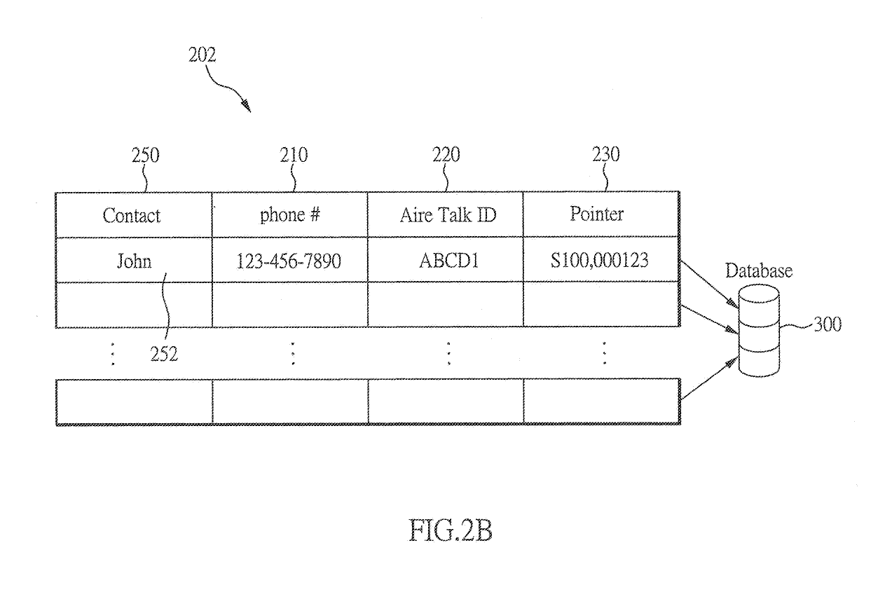

Referring to FIG. 2A, a generalize block diagram illustrating a Lookup Partition Table, according to an embodiment of the invention. The Lookup Partition Table (LPT) 200 resides in AireCenter box 110 of FIG. 1. Each entry (or row) in LPT 200 corresponds to a registered AK member and has at least three fields (shown as three columns) that include a ported phone number 210, an identification code 220 and a pointer 230. An entry is created whenever an AK member registers with AireTalk and is replicated on systems in clouds around the world for fast and/or easy access by users in different geographical locations. The entries are updated when the registered AK members change any information and synchronized with all copies of the entries in real time.

In one embodiment, the phone number field 212 (e.g. 123-456-7890) of first entry includes a ported phone number of the AK member into AireCenter 110. This is the number that a 3^{rd} party can dial to connect to all the AK member's devices. The Identification (ID) field 222 (e.g. ABCD1) of first entry is a unique ID of a registered AK member within a platform enabled by UC technology and is also used to associate with any non-PSTN devices, such as PCs, tablets 160 and TVs 180. This ID can be either alphanumeric or a PSTN number. The phone number field 210 and ID 220 together can cover all PSTN and non-PSTN devices. Although two fields are used, it may be possible to use only one field to cover both PSTN and non-PSTN devices. The pointer field 232 (e.g. S100,000123) of first entry contains a pointer pointing to a database 300 that has more detailed information of the registered AK member associated with the first entry of LPT. The pointer has certain format for fast and/or easy access to database 300, such as indicators (e.g. a few bits of the pointer) representing where in the cloud is more efficient for access. For example, the first three digits (e.g. 100 in the illustrated example) may indicate a country and the fourth to sixth digits may indicate geographical locations within that country, and so on. There might be other ways to help locate the database as long as they can provide fast and efficient access.

FIG. 2B is a generalize block diagram illustrating another embodiment of lookup table called TV Lookup Partition Table (TVLPT), according to an embodiment of the invention. TVLPT 202 is similar to that of FIG. 2A for TV initiated connect request. It has an extra column of “contacts” 250 which can be the names or nicknames of registered AK members. This field is used when a TV user selects a person's name or speaks a person's name to a voice recognition device. The selection triggers the connection request to reach a receiver (or a recipient entity) associated with the selected contact such as “John” 252 illustrated in this figure.

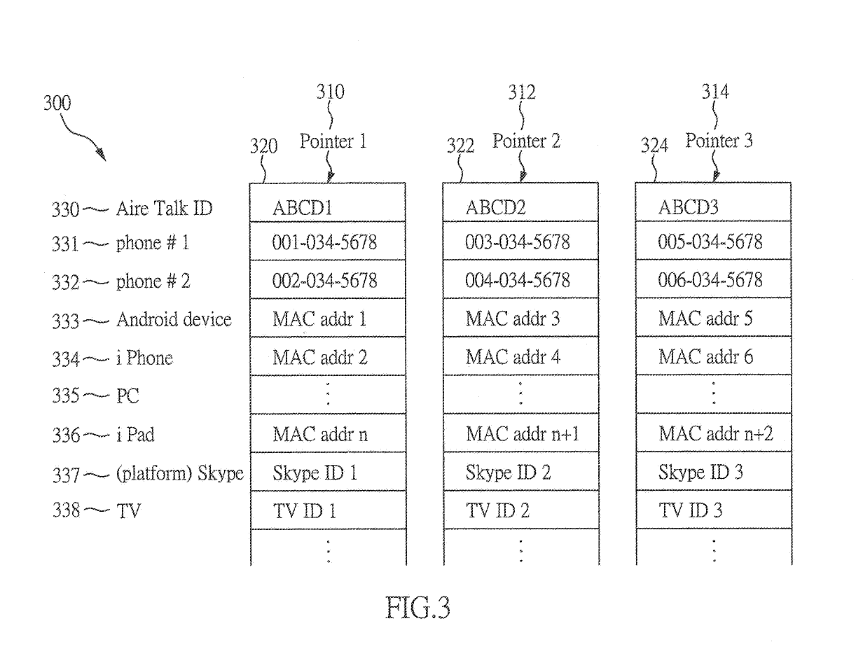

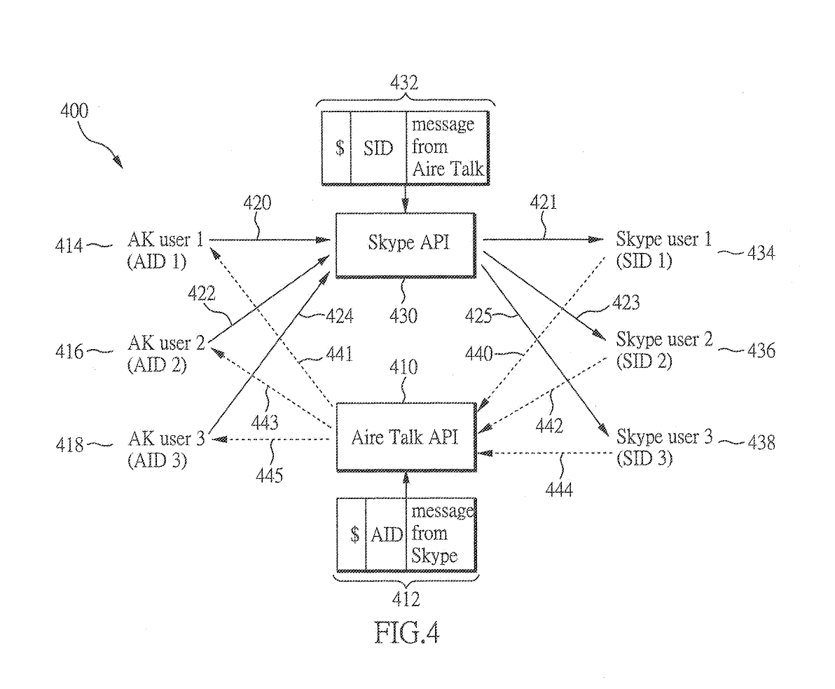

FIG. 3 is a generalize block diagram illustrating a database pointed to by the LPT or TVLPT entries, according to an embodiment of the invention. The database 300 has many blocks of data 320-324 and each block of data is pointed to by a pointer respectively (310, 312 and 314). Each block of data contains various kinds of registered AK member's information. In one embodiment, an ID field 330 of data block 320 includes an AireTalk registration ID which is similar to ID field 220 in LPT of FIG. 2A. There are several phone number fields 331-332 associated with phones owned by the AK member, for example, work phones, home phones and mobile phones. The AK member can select one of these phone numbers to be used as a ported phone number in phone number field 210 of LPT for incoming connection requests. There is also one or more Media Access Control (MAC) addresses associated with smart phones/devices (e.g. MAC address1 333 for Android device and MAC address2 334 for iPhone), PCs 335 and tablets 336 for internet communication. These devices with MAC addresses are enabled by AireTalk software applications. In an embodiment, smart phones/devices 333-334 can be reached by phone numbers for voice call or MAC addresses for data communication while PC 335 and tablets 336 are reached by MAC addresses. Although only one of each device type is listed in FIG. 3, the Universal Connectivity technology allows a plurality of same device types to be used. A field of communication platform's ID 337, such as Skype, in this figure includes AK member's Skype identification for communicating to Skype's application. Further details about the usage of this field will be discussed in relation to FIG. 4. The last field is TV field 338, which can include one or more unique identifications associated with an internet enabled TV. For example, this unique TV identification may be a MAC address or a unique name for the TV device. The TV can be reached whether the connection request is a PSTN phone call or an internet connection request. Although FIG. 3 illustrates only one identification field for TV, more than one TV's unique identification may be separated into multiple fields in Database.

The database 300 may be arranged by various structures on storage devices, as in segments or rings or other ways and is distributed worldwide to store local user's information. For example, there are database in Asia for Asian users, database for in Europe European users and database in North America for North American users. Each user's information is grouped as a region and pointed to by a pointer from LPT. The database is also created or updated accordingly with its corresponding LPT entry whenever a change is detected in either database or LPT.

FIG. 4 is a generalize block diagram illustrating a communication protocol between two platforms, according to an embodiment of the invention. As illustrated in this figure, it may include two platforms, AireTalk 410 and Skype 430. Although Skype is illustrated here as an example, similar protocol can be used in various kind of communication platforms, such as Line, WeChat and Google Voice. Since Skype is a software application running on different operating systems and has its own infrastructure, it may require additional processing or conversions, as an example transcoder 172 of FIG. 1, to communicate with AireCenter (i.e. an AireTalk platform) in FIG. 1. In FIG. 4, three AK users 414, 416 and 418 who are using applications on AireTalk platform are communicating with three Skype users 434, 436 and 438 who are on Skype platform. When AK user1 414 with AireTalk ID1 (AID1) tries to reach a Skype user1 434 with Skype ID1 (SID1), the message 420 from AK user1 414 is transcoded by an Application Program Interface (API) 430 provided by Skype in a format (e.g. “$SID1.message”) 432 that can be recognized by Skype's application. As illustrated here, ‘$’ is a delimiter for use as an indicator of the start of a message in a data packet. “SID1” is the Skype ID of Skype user1 434 who is also an AK member. “message” is the message that AK user1 414 tries to convey to Skype user1 434. This communication corresponds to the communication path in FIG. 1 where AK user 120 sends a message through AireCenter 110 and transcoder 172 to reach a platform 170 (e.g. Skype) used by a Skype user who is an AK member.

Conversely, when Skype user2 436 with Skype ID2 (SID2) tries to reach AK user2 416 with AireTalk ID2 (AID2), the message 442 from Skype user2 436 can be transcoded by an API 410 provided by AireTalk in a format (e.g. $AID2.message) 412 that can be recognized by AireTalk's application. As illustrated here, ‘$’ is a delimiter for use as an indicator of the start of a message in a data packet. “AID2” is the AireTalk ID of AK user2 416. “message” is the message that Skype user2 436 tries to convey to AK user2 416. This communication corresponds to a communication path in FIG. 1 where a non-AK user 130 sends a message through AireCenter 110 and then transcoder 172 to reach an application on a platform 170 (e.g. AireTalk) used by an AK user. The communication messages between AK users and Skype users may include, but not limited to, voice, text, chat or video. Although the communication above appears to be one-to-one communication, a communication involving a plurality of users simultaneously may be possible.

Still referring to FIG. 4, the format of transcoded message 412 by AireTalk API 410 includes three fields. The first field 412.1 is a delimiter for detection as start of a transcoded message in a data packet and is shown as “$” in this figure as an example. The second field 412.2 is the AireTalk ID for AireTalk platform to identify the receiving AK user. The third field 412.3 is the message itself from Skype user2 436. The AireTalk ID in 412.2 may be obtained in two ways. In one way, if the Skype user2 436 knows this AireTalk ID, the Skype user2 436 can enter it directly in Skype application. In another way, the Skype user2 436 can use AK user2's 416 phone number and AireCenter can lookup AK user2's 416 AireTalk ID in LPT 200.

Similarly, the format of transcoded message 432 by SkypeAPI 430 includes three fields. The first field 432.1 is a delimiter for detection as start of transcoded message in a data packet and is shown as “$” in this figure as an example. The second field 432.2 is the Skype ID for Skype platform to identify the receiving Skype user of an AK member. The third field 432.3 is the message itself from an AK user1 414. This Skype ID 432.2 may be obtained in two ways. In one way, if the AK user1 414 knows this Skype ID, the AK user1 414 can enter it directly in AireTalk application. In another way, the AK user1 414 can use Skype user1's 434 phone number and AireCenter can lookup LPT 200 which points to a database field 337 containing the SkypeID of Skype user1 434 if this user is also an AK member.

In one embodiment, this communication protocol can allow a 3^{rd} party to reach a registered AireTalk (AK) member using an application of other platform supporting this communication protocol. For example, a 3^{rd} party can call the AK member's ported phone number. The AireCenter 110 with AireTalk applications can look up the phone number 210 in LPT 200 and the follow its corresponding pointer 230 to find the AK member's platform ID 337 in database 300 and connect to the AK member.

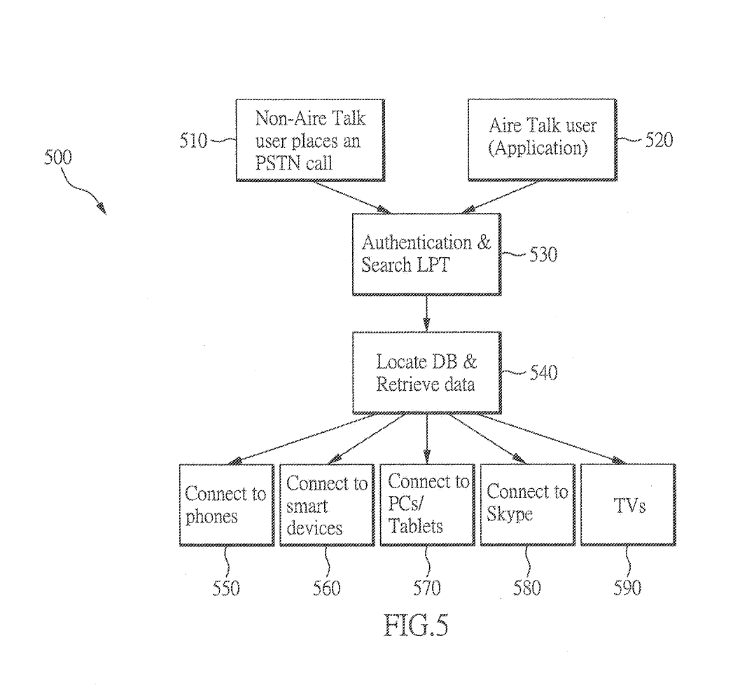

FIG. 5 is a generalize flow diagram illustrating a method for processing connection requests with the Universal Connectivity technology in AireCenter, according to an embodiment of the invention. In step 510, a non-AK user may place a PSTN phone call by dialing a ported phone number of an AK member. In step 530, AireCenter authenticates the phone call for access and searches the LPT 200 to find the phone number. When a match is found, the corresponding AireTalk ID in the matched entry of LPT is retrieved and a pointer is read to determine the location of relevant database with most efficient access. Next, in step 540, AireCenter finds the target database by following the pointer to locate a region that contains the information of the AK member. One or more of the AK member's information is retrieved and processed. When there are multiple phone numbers, AireCenter may forward the call to one or more of these corresponding phones depending on configuration through phone switching system as in step 550. In step 560 for other smart devices, MAC addresses are read and AireCenter invokes VoIP calls to those devices corresponding to the identified MAC address. In step 570 for PC and tablets which also use MAC address, AireCenter uses similar method of VoIP calls to reach them. In step 580, when a platform ID (e.g. SkypeID) exists in the located database, AireCenter may communicate to Skype API to transcode the incoming call with SkypeID and forward it to the corresponding Skype user. In step 590, AireCenter identifies a TV ID from database, checks the availability of target TV with this ID and establish communication if the target TV is available. As a result, the call made by the non-AK user can reach all communication devices of the AK member, namely PSTN phones, smart devices such as Android based or iOS based devices, PC/Tablet, Skype and TV. In addition to ringing all devices, a caller (or sender entity or connection requester) can set priority or selectively connect to only a subset of devices, for example an individual device or a specific type of devices or frequently used devices.

Still referring to FIG. 5, in step 520, when a connection request is made by an AK user (referred to herein as first AK user), there are two ways the first AK user can communicate with another AK user (referred to as second AK user). In one way, the first AK user can dial a phone number using a smart phone/device or TV with AireTalk application to make the connection request (e.g. phone call). The AireTalk application would search LPT 200 to lookup and authenticate AireTalk ID of the second AK user associated with the dialed phone number. It then proceeds to step 540 to locate DB and retrieve downstream phone numbers, MAC addresses and IDs. Subsequently, AireCenter would proceed to establish connection as in steps 550-590 with various devices by using retrieved information.

In another way, if the first AK user has a PC or a tablet or a TV, the AireTalk application, as in step 530, may displays a list of contacts of AK members including the second AK user. The first AK user can select a contact directly from the AireTalk application and use the associated AireTalk ID of that contact to communicate. The phone number is not involved in this method. The communication process for AK user (step 520) is the same as that of non-AK user (step 510) except that the connection request is initiated by AireTalk application rather than PSTN phone call.

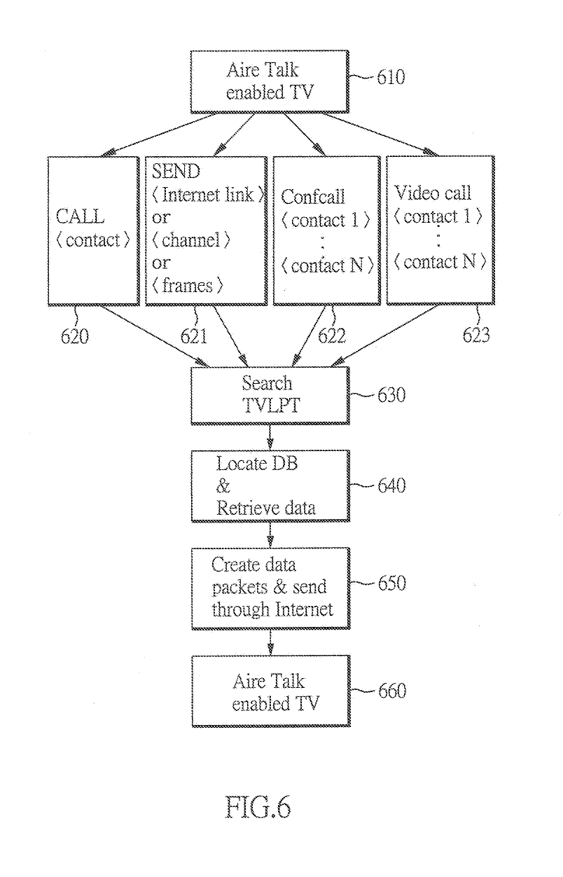

FIG. 6 is a generalize flow diagram illustrating another embodiment of a method for processing a connection request, according to an embodiment of the invention. In particular, it is a part of flow diagram in FIG. 5 specifically for TV to TV communication and information sharing. A connection request is initiated by an AireTalk enabled TV 610. This AireTalk enabled TV may be a Web TV connected to a separate hardware box with Universal Connectivity (UC) technology or a TV that has built-in UC technology. The AireTalk enabled TV is associated with an AireTalk ID and therefore considered as an AireTalk user such as the one in 520 of FIG. 5. This TV can generate various commands in response to a user's requests through AireTalk applications on the TV. In one embodiment, in step 620, a user can select a contact to call and the selection invokes a command “call <contact>”. The receiving devices for this feature may be PSTN phones, smart devices, communication platforms or another TV as discussed in FIG. 5. In step 621, a user can send a specific internet link or channel information or displayed frames on TV by capturing the corresponding information on TV and send to a selected contact with the command “SEND<internet link/channel/frame(s)>”. In step 622, a user can also request to make a conference call to several contacts with the command “ConfCall<contact1 . . . contact>. Alternatively, in step 623, the user can make a video call to several contacts with the command VideoCall<contact1 . . . contact>. These requests are translated into various corresponding commands to invoke AireTalk to lookup the TVLPT 202 and find one or more pointers as in step 630 depending on the commands invoked. For example, in step 620 with command “call<contact>”, AireTalk only needs to find one pointer that point to the database corresponds to the selected <contact>. Yet, for another example as in step 623, AireTalk will need to find N pointers that correspond to <contact1> to <contactN>.

Next, in step 640, AireCenter follows the identified one or more pointers to locate database pointed to by the one or more pointers and retrieve TV IDs of each database associated with selected contacts. In step 650, AireTalk enabled TV creates data packets based on captured information and transmit the packets over the internet to one or more AireTalk enabled TVs in step 660.

In addition to those user-initiated requests on TV, an AireTalk enabled TV may be connected to other local devices such as sensors or surveillance system. The TV may be programmed to automatically initiate connection request (e.g. SEND command) and send captured information from the connected local devices to one or more pre-selected contacts, as described in the process of FIG. 6.

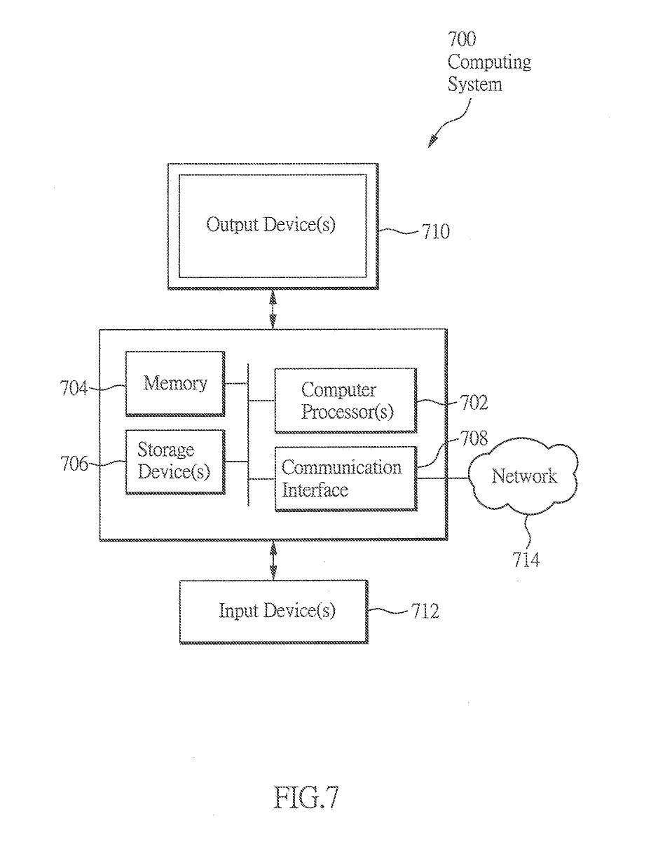

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 7, the computing system 700 may include one or more computer processor(s) 702, associated memory 704 (e.g., random access memory (RAM), cache memory, flash memory, etc.), one or more storage device(s) 706 (e.g., a hard disk, an optical drive such as a compact disk (CD) drive or digital versatile disk (DVD) drive, a flash memory stick, etc.), and numerous other elements and functionalities. The computer processor(s) 702 may be an integrated circuit for processing instructions. For example, the computer processor(s) may be one or more cores, or micro-cores of a processor. The computing system 700 may also include one or more input device(s) 712, such as a touch screen, keyboard, mouse, microphone, touchpad, electronic pen, or any other type of input device. Further, the computing system 700 may include one or more output device(s) 710, such as a screen (e.g., a liquid crystal display (LCD), a plasma display, touch screen, cathode ray tube (CRT) monitor, projector, or other display device), a printer, external storage, or any other output device. One or more of the output device(s) may be the same or different from the input device(s). The computing system 700 may be connected to a network 714 (e.g., a local area network (LAN), a wide area network (WAN) such as the Internet, mobile network, or any other type of network) via a communication interface 708. The communication interface may be an integrated services digital network (ISDN) card, cable modem, satellite modem, or a modem to provide a data communication connection to a corresponding type of telephone line. The input and output device(s) may be locally or remotely (e.g., via the network 714) connected to the computer processor(s) 702, memory 704, and storage device(s) 706. Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, firmware or any other computer readable storage medium. Specifically, the software instructions may correspond to computer readable program code that when executed by a processor(s), is configured to perform embodiments of the invention.

Further, one or more elements of the aforementioned computing system 700 may be located at a remote location and connected to the other elements over a network 714. Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### DEFINITIONS

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

“Comprising.” This term is open-ended. As used in the appended claims, this term does not foreclose additional structure or steps. Consider a claim that recites: “A computing system comprising a physical memory . . . ” Such a claim does not foreclose the computing system from including additional components (e.g., a cache, a memory controller).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, paragraph (f), for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Computer-readable medium.” This term refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can function with. Each type of media, if selected for implementation in one embodiment, includes stored instructions of an algorithm configured to perform one or more of the disclosed and/or claimed functions. For example, a non-transitory computer-readable medium may store computer-executable instructions that are part of an algorithm that, when executed by a computer, cause the computer to perform one of the disclosed methods, the instructions comprising instructions configured for performing one or more disclosed and/or claimed functions.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method for communication, comprising:
receiving a phone connection request with a target phone number from a source device;
authenticating said phone connection request for access to a network;
identifying a plurality of receiving devices associated with the target phone number; and
transmitting signals to all said identified plurality of receiving devices at substantially the same time;
wherein said plurality of receiving devices include at least one PSTN device and at least one non-PSTN device.

2. The method of claim 1, wherein said authenticating further comprises looking up and verifying a unique personal identification for a recipient entity associated with said plurality of receiving devices.

3. The method of claim 2, wherein said identifying comprises:
in response to said phone connection request, converting said target phone number into one or more downstream phone numbers for said at least one receiving PSTN device; and
converting said target phone number into one or more network addresses for said at least one receiving non-PSTN device;
wherein said one or more downstream phone numbers and said one or more network addresses are associated with said unique personal identification.

4. The method of claim 3, wherein said one or more network addresses comprise Media Access Control (MAC) addresses.

5. The method of claim 3, wherein said converting target phone number into one or more network addresses further comprises:
obtaining an identification of a networked communication platform associated with a recipient entity; and
encoding said platform identification with a transmitted message into a message packet format recognizable by said networked communication platform;
wherein said at least one non-PSTN device operates on said communication platform.

6. The method of claim 3, wherein said converting target phone number into one or more network addresses further comprises:
obtaining an identification of a networked television (TV) associated with a recipient entity;
wherein said TV identification is unique within a network of TVs.

7. The method of claim 1, wherein said source device is a non-PSTN device.

8. The method of claim 7, wherein said non-PSTN device is a network enabled TV.

9. A communication system, comprising:
a receiver subsystem configured to receive a phone connection request with a target phone number from a source device;
a processing subsystem configured to:
authenticate said phone connection request for access to a network;
identify a plurality of receiving devices associated with the target phone number; and
a transmitter subsystem configured to transmit signals to all said identified plurality of receiving devices at substantially the same time;
wherein said plurality of receiving devices include at least one PSTN device and at least one non-PSTN device.

10. The communication system of claim 9, wherein said processing subsystem is configured to look up and verify a unique personal identification for a recipient entity associated with said plurality of receiving devices.

11. The communication system of claim 10, wherein said processing subsystem is configured to:
in response to said phone connection request, convert said target phone number into one or more downstream phone numbers for said at least one receiving PSTN device; and
convert said target phone number into one or more network addresses for said at least one receiving non-PSTN device;
wherein said one or more downstream phone numbers and said one or more network addresses are associated with said unique personal identification.

12. The communication system of claim 11, wherein said one or more network addresses comprise Media Access Control (MAC) addresses.

13. The communication system of claim 11, further comprises a transcoder configured to:
obtain an identification of a networked communication platform associated with a recipient entity; and
encode said platform identification with a transmitted message into a message packet format recognizable by said networked communication platform;
wherein said at least one non-PSTN device operates on said networked communication platform.

14. The communication system of claim 11, wherein said processing subsystem is configured to obtain an identification of a networked television (TV) associated with a recipient entity, wherein said TV identification is unique within a network of TVs.

15. The communication system of claim 9, wherein said source device is a non-PSTN device.

16. The communication system of claim 15, wherein said non-PSTN device is a network enabled TV.

17. A method for TV communication, comprising:
receiving a connection request from a source network enabled TV to at least one destination network enabled TV associated with a personal identification of a recipient entity;
looking up a network identification of said at least one destination networked enabled TV; and
transmitting signals to said at least one destination networked enabled TV.

18. The method of claim 17, wherein said signals include information captured on said source network enabled TV, wherein said captured information is images displayed on said source network enabled TV or data from local devices connected to said source network enabled TV.

19. The method of claim 17, further comprising a plurality of destination networked enabled TVs, wherein each destination networked enabled TV is associated with unique network identification.

20. The method of claim 19, wherein said signals include phone conference call or video conference call.

21. A system for TV communication, comprising:
a receiver subsystem configured to receive a connection request from a source network enabled TV to at least one destination network enabled TV associated with a personal identification of a recipient entity;
a processing subsystem configured to look up a network identification of said at least one destination networked enabled TV;
a transmitter subsystem configured to transmit signals to said at least one destination networked enabled TV.

22. The system of claim 21, wherein said signals include information captured on said source network enabled TV, wherein said captured information is images displayed on said source network enabled TV or data from local devices connected to said source network enabled TV.

23. The system of claim 21, further comprising a plurality of destination networked enabled TVs, wherein each destination networked enabled TV is associated with unique network identification.

24. The system of claim 23, wherein said signals include phone conference call or video conference call.
